(19) United States
(12) Patent Application Publication
(10) Pub. No.: US 2012/0293035 A1
(43) Pub. Date: Nov. 22, 2012

(54) CORELESS ELECTRIC MACHINE APPARATUS, MOVING BODY AND ROBOT

(75) Inventors: Kazuyoshi NAKAMURA, Azumino (JP); Kesatoshi TAKEUCHI, Shiojiri (JP)

(73) Assignee: SEIKO EPSON CORPORATION, Tokyo (JP)

(21) Appl. No.: 13/471,863

(22) Filed: May 15, 2012

(30) Foreign Application Priority Data
May 16, 2011 (JP) 2011-108958

(51) Int. Cl. H02K 3/04

(52) U.S. Cl. 310/208

(57) ABSTRACT

A coreless electric machine apparatus includes: a permanent magnet arranged on the first member; two-phase coreless electromagnetic coils arranged on the second member; a coil back yoke arranged on the second member, wherein the electromagnetic coils include effective coil areas for generating a force to move the first member relatively to the second member, and coil end areas, the effective coil areas of the two-phase electromagnetic coils have same shape and are arranged in a cylindrical area between the permanent magnet and the coil back yoke, the coil end area of a first phase electromagnetic coil of the two-phase electromagnetic coils is bent in an inside direction or an outside direction of the cylindrical surface, the two-phase electromagnetic coils have same electric resistance value, and the coil back yoke covers outer peripheral areas of the effective coil areas and does not cover outer peripheral areas of the coil end areas.

### BACKGROUND

1. Technical Field

The present invention relates to an electric machine apparatus such as a coreless electric motor or a generator.

2. Related Art

An electric motor is known in which an inner coil and an outer coil are wound around teeth, and a coil end of the outer coil is bent outward (for example, JP 2010-246342). In this electric motor, the teeth and the coils (electromagnetic coils) form an electromagnet, and the motor rotates by the interaction between the electromagnet and a permanent magnet.

However, in a coreless electric motor without teeth, an electromagnetic coil does not form an electromagnet, and rotates by the Lorentz force between current flowing through the electromagnetic coil and a permanent magnet and the reaction thereof. In the coreless electric motor as stated above, the electric resistance and inductance of the electromagnetic coil influence the Lorentz force. In the case of the coreless electric motor including two-phase electromagnetic coils, there is a problem that it is difficult to arrange the electromagnetic coils in such a way that the electric resistances and inductances of the electromagnetic coils of the respective phases becomes equal to each other, and it is difficult to improve the efficiency of the coreless electric motor (electric machine apparatus).

### SUMMARY

An advantage of some aspects of the invention is to improve the efficiency of a coreless electric machine apparatus by causing electric resistances and inductances of two-phase electromagnetic coils to be substantially equal to each other.

### Application Example 1

This application example of the invention is directed to a coreless electric machine apparatus including a first and second cylindrical members movable relative to each other, and includes a permanent magnet arranged on the first member, two-phase coreless electromagnetic coils arranged on the second member, a coil back yoke arranged on the second member. The electromagnetic coils include effective coil areas for generating a force to move the first member relatively to the second member, and coil end areas. The effective coil areas of the two-phase electromagnetic coils have same shape and are arranged in a cylindrical area between the permanent magnet and the coil back yoke. The coil end area of a first phase electromagnetic coil of the two-phase electromagnetic coils is bent in an inside direction or an outside direction of the cylindrical surface. The two-phase electromagnetic coils have same electric resistance value, and the coil back yoke covers outer peripheral areas of the effective coil areas and does not cover outer peripheral areas of the coil end areas.

In the case of the coreless electric machine apparatus including the coil back yoke, a portion of the electromagnetic coil overlapping the coil back yoke greatly contributes to the value of the inductance of the electromagnetic coil. Accordingly, according to this application example of the invention, since the electric resistances and the inductances of the two-phase electromagnetic coils can be made substantially the same, the efficiency of the coreless electric machine apparatus can be improved.

### Application Example 2

This application example of the invention is directed to the coreless electric machine apparatus according to the above application example, wherein a shape of the first phase electromagnetic coil before the coil end area is bent is equal to a shape of a second phase electromagnetic coil, and the coil end area of the first phase electromagnetic coil is bent in the inside direction or the outside direction of the cylindrical surface.

According to this coreless electric machine apparatus, the two-phase electromagnetic coils have the same shape, that is, the same electric resistance and the same inductance in the flat state where the coil end areas are not bent, and the one-phase electromagnetic coil is formed by bending the portion of the coil end which hardly influences the value of the inductance. Thus, the electric resistances and inductances of the two-phase electromagnetic coils can be made substantially the same.

### Application Example 3

This application example of the invention is directed to the coreless electric machine apparatus according to Application Example 1 or 2, wherein the coil end area of the second phase electromagnetic coil of the two-phase electromagnetic coils is bent in a direction opposite to the direction in which the coil end area of the first phase electromagnetic coil is bent.

According to this coreless electric machine apparatus, since the other electromagnetic coil is also bent, a slight difference between the inductance values of the two-phase electromagnetic coils can be reduced.

### Application Example 4

This application example of the invention is directed to the coreless electric machine apparatus according to any of Application Examples 1 to 3, wherein an interval between the two-phase electromagnetic coils forming the effective coil areas is twice a thickness of the electromagnetic coil in the effective coil area of the electromagnetic coil.

According to this coreless electric machine apparatus, since an occupancy factor of the electromagnetic coil can be raised, the efficiency of the coreless electric machine apparatus can be improved.

### Application Example 5

This application example of the invention is directed to a moving body including the coreless electric machine apparatus according to any of Application Examples 1 to 4.

### Application Example 6

This application example of the invention is directed to a robot including the coreless electric machine apparatus according to any of Application Examples 1 to 4.

The invention can be realized in various forms, and can be realized in forms of, for example, a coreless electric machine apparatus such as a motor or a generating apparatus, and further, in forms of a moving body or a robot using the same.

### BRIEF DESCRIPTION OF THE DRAWINGS

The invention will be described with reference to the accompanying drawings, wherein like numbers reference like elements.

FIGS. 1A and 1B are explanatory views showing a first embodiment.

FIGS. 2A to 2D are enlarged explanatory views showing the vicinity of a coil end area of an electromagnetic coil.

FIG. 3 is an enlarged explanatory view showing a difference between the coil shapes of electromagnetic coils 100A and 100B.

FIG. 4A is an explanatory view showing a state where the electromagnetic coils 100A and 100B are formed on a plane.

FIG. 4B is an explanatory view showing a state before the electromagnetic coils 100A and 100B are overlapped.

FIG. 4C is an explanatory view showing a state where the electromagnetic coils 100A and 100B are overlapped.

FIGS. 5A and 5B are explanatory views showing a second embodiment.

FIG. 6 is an enlarged explanatory view showing a difference between coil shapes of electromagnetic coils 100A and 100B of the second embodiment.

FIGS. 7A and 7B are explanatory views showing a third embodiment.

FIG. 8 is an enlarged explanatory view showing a difference between coil shapes of electromagnetic coils 100A and 100B of the third embodiment.

FIG. 9 is an explanatory view showing an electric bicycle (electric assist bicycle) as an example of a moving body using a motor/generator according to a modified example of the invention.

FIG. 10 is an explanatory view showing an example of a robot using a motor according to a modified example of the invention.

FIG. 11 is an explanatory view showing a rail vehicle using a motor according to a modified example of the invention.

### DESCRIPTION OF EXEMPLARY EMBODIMENTS

### First Embodiment

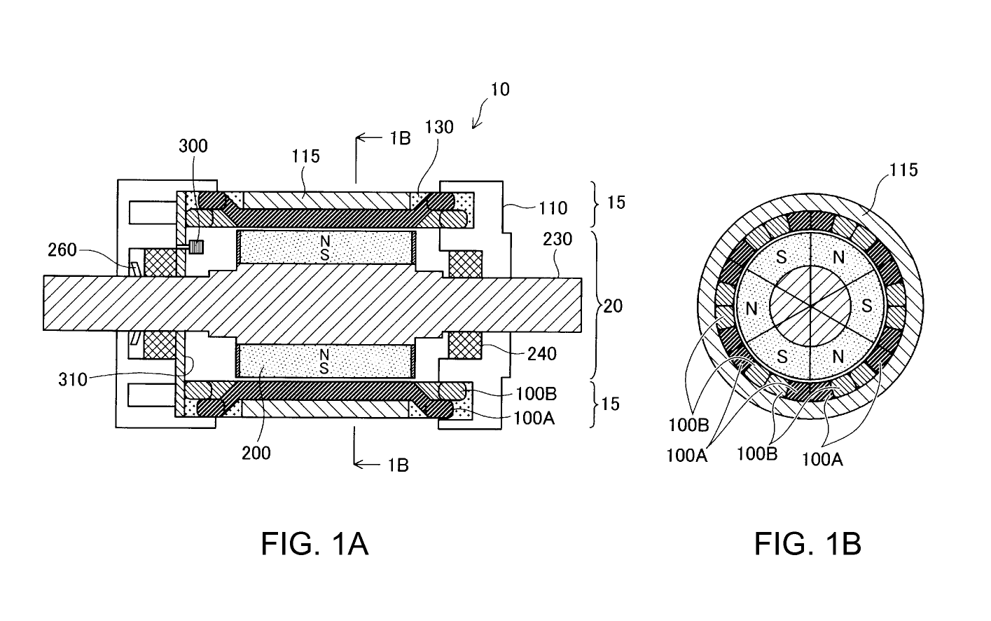

FIGS. 1A and 1B are explanatory views showing a first embodiment. FIG. 1A is a schematic view showing a section of an electric motor 10 cut along a plane parallel to a rotation shaft 230 and viewed from a direction perpendicular to the section. FIG. 1B is a schematic view showing a section of the electric motor 10 cut along a cut line 1B-1B perpendicular to the rotation shaft 230 and viewed from a direction perpendicular to the section. The electric motor 10 is an inner rotor motor of a radial gap structure in which a substantially cylindrical stator 15 is arranged on an outside and a substantially cylindrical rotor 20 is arranged on an inside. The stator 15 includes a coil back yoke 115 arranged along an inner periphery of a casing 110, and plural electromagnetic coils 100A and 100B arranged inside the coil back yoke 115. In this embodiment, if the electromagnetic coils 100A and 100B are not distinguished from each other, each of them is simply called an electromagnetic coil 100. The coil back yoke 115 is formed of a magnetic material and has a substantially cylindrical shape. The electromagnetic coils 100A and 100B are molded with a resin 130 and are arranged on the same cylindrical surface. The lengths of the electromagnetic coils 100A and 100B in the direction along the rotation shaft 230 are longer than the length of the coil back yoke 115 in the direction along the rotation shaft 230. That is, in FIG. 1A, ends of the electromagnetic coils 100A and 100B in the right-and-left direction do not overlap the coil back yoke 115. In this embodiment, an area where the electromagnetic coil overlaps the coil back yoke 115 is called an effective coil area, and an area where the electromagnetic coil does not overlap the coil back yoke 115 is called a coil end area. In this embodiment, although the effective coil area and the coil end area of the electromagnetic coil 100B, and the effective coil area of the electromagnetic coil 100A are on the same cylindrical surface, the coil end area of the electromagnetic coil 100A is bent outward from the cylindrical surface.

The stator 15 further includes a magnetic sensor 300 as a position sensor to detect the phase of the rotor 20. As the magnetic sensor 300, for example, a hall sensor including a hole element can be used. The magnetic sensor 300 generates a substantially sine-wave sensor signal. The sensor signal is used to generate a drive signal to drive the electromagnetic coil 100. Accordingly, it is preferable to provide two magnetic sensors 300 corresponding to the electromagnetic coils 100A and 100B. The magnetic sensor 300 is fixed on a circuit board 310, and the circuit board 310 is fixed to the casing 110.

The rotor 20 includes the rotation shaft 230 at the center, and includes plural permanent magnets 200 at the outer periphery. Each of the permanent magnets 200 is magnetized along a radius direction (radiation direction) from the center of the rotation shaft 230 to the outside. Incidentally, in FIG. 1B, reference characters N and S given to the permanent magnets 200 represent polarities of the permanent magnets 200 on the electromagnetic coils 100A and 100B side. The permanent magnet 200 and the electromagnetic coil 100 are arranged to face the cylindrical facing surfaces of the rotor 20 and the stator 15. Here, the length of the permanent magnet 200 in the direction along the rotation shaft 230 is the same as the length of the coil back yoke 115 in the direction along the rotation shaft 230. That is, an area where an area sandwiched between the permanent magnet 200 and the coil back yoke 115 overlaps the electromagnetic coil 100A or 100B is the effective coil area. The rotation shaft 230 is supported by a bearing 240 of the casing 110. In this embodiment, a wave spring washer 260 is provided inside the casing 110. The wave spring washer 260 performs positioning of the permanent magnet 200. However, the wave spring washer 260 can be replaced by another component.

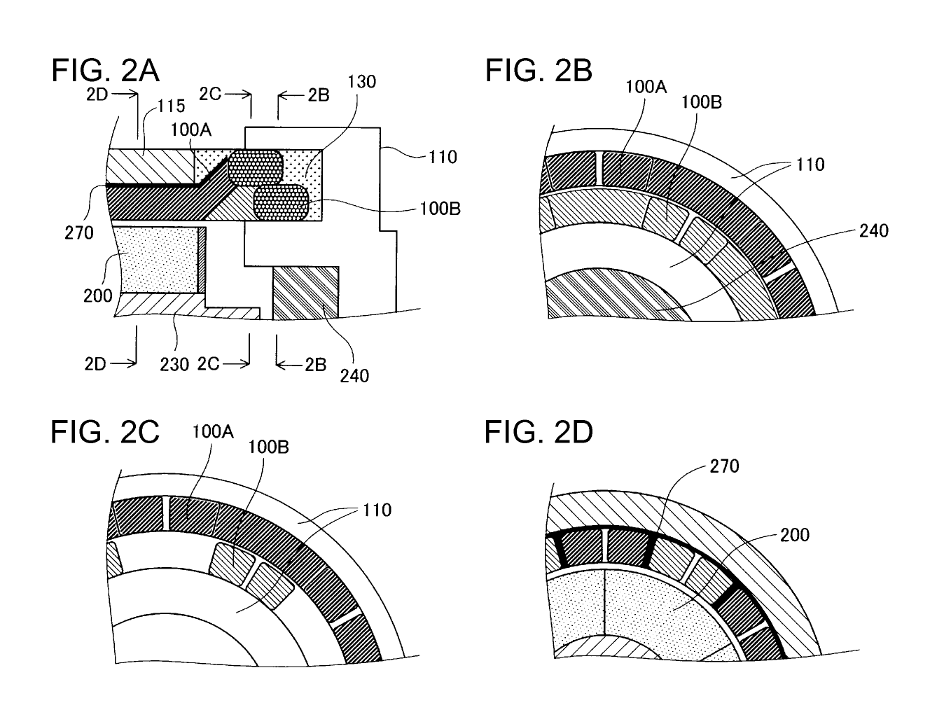

FIGS. 2A and 2D are enlarged explanatory views showing the vicinity of the coil end area of the electromagnetic coil. FIG. 2A is a schematic view showing a section of the electric motor 10 cut along the plane parallel to the rotation shaft 230 and viewed from a direction perpendicular to the section. FIG. 2B is a view showing a section of the electric motor 10 cut along a cut line 2B-2B perpendicular to the rotation shaft 230 and viewed from a direction perpendicular to the section. FIG. 2C is a view showing a section of the electric motor 10 cut along a cut line 2C-2C perpendicular to the rotation shaft 230 and viewed from a direction perpendicular to the section. FIG. 2D is a view showing a section of the electric motor 10 cut along a cut line 2D-2D perpendicular to the rotation shaft 230 and viewed from a direction perpendicular to the section. FIGS. 2A and 2D show a coil guide 270. Here, the cut line 2B-2B and the cut line 2C-2C are cut lines crossing the coil end areas of the electromagnetic coils 100A and 100B, and the cut line 2D-2D is a cut line crossing the effective coil areas of the electromagnetic coils 100A and 100B. The coil guide 270 is used to facilitate positioning of the electromagnetic coils 100A and 100B when the electromagnetic coils 100A and 100B are arranged.

In the section shown in FIG. 2B, both a conductive wire forming the electromagnetic coil 100A and a conductive wire forming the electromagnetic coil 100B are in a direction along the circumference of the cylindrical surface. Besides, in this section, since the electromagnetic coil 100A is bent in the outside direction of the cylindrical surface, the electromagnetic coil 100A is on the outside circumference, and the electromagnetic coil 100B is on the inside circumference. The electromagnetic coil 100A is bent in the outside direction of the cylindrical surface in order to prevent the occurrence of such a state that the electromagnetic coils 100A and 100B collide with each other and can not be installed. In the section shown in FIG. 2C, although the wiring direction of the conductive wire forming the electromagnetic coil 100A is the direction along the circumference of the cylindrical surface, the wiring direction of the conductive wire forming the electromagnetic coil 100B is a front-back direction of the drawing, and is a direction parallel to the rotation shaft 230. In the section shown in FIG. 2D, the wiring directions of both the conductive wire forming the electromagnetic coil 100A and the conductive wire forming the electromagnetic coil 100B are the front-back direction of the drawing, and are the direction parallel to the rotation shaft 230.

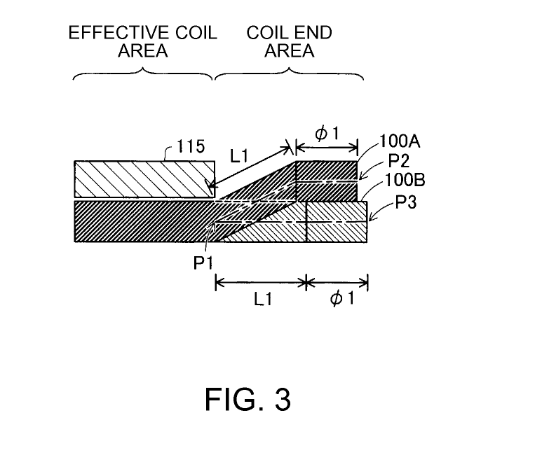

FIG. 3 is an enlarged explanatory view showing a difference between the coil shapes of the electromagnetic coils 100A and 100B. The electromagnetic coil 100A is bent outward at P1 where the electromagnetic coil 100A does not overlap the coil back yoke 115. The length from the bent part P1 to an end P2 of the electromagnetic coil 100A is (L1+φ1). Here, φ1 denotes the thickness of a set of conductors forming the electromagnetic coil 100A in the direction along the cylindrical surface. Besides, the length of the electromagnetic coil 100B from P1 where the coil 100A is bent to an end P3 of the electromagnetic coil 100B is (L1+φ1). That is, the electromagnetic coils 100A and 100B before bending have the same length in the rotation shaft direction of the rotor, and the electric resistance of the electromagnetic coil 100A and the electric resistance of the electromagnetic coil 100B have the same value.

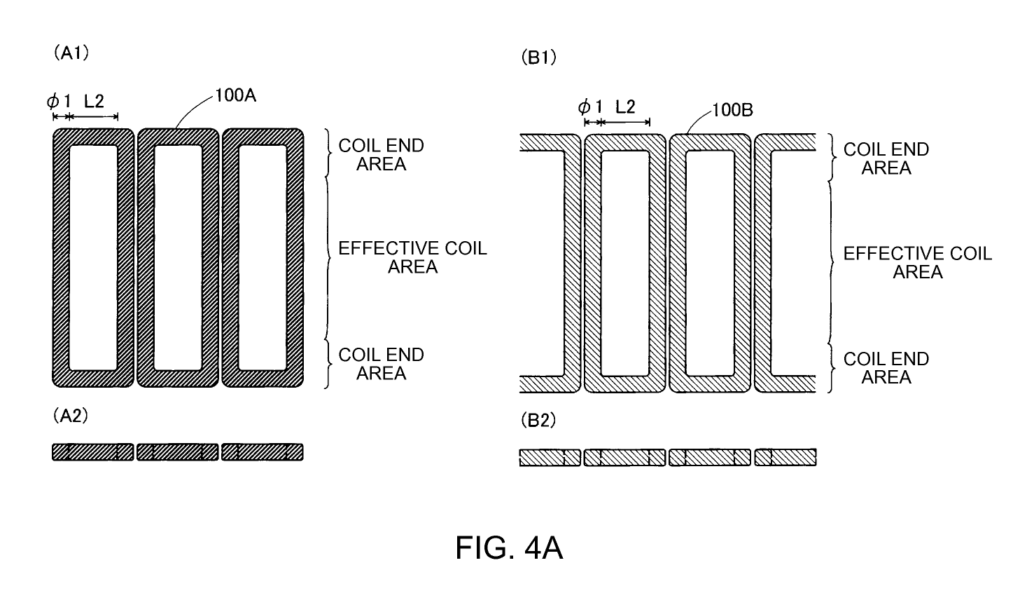

FIG. 4A is an explanatory view showing a state where the electromagnetic coils 100A and 100B are formed on a plane. FIG. 4A(A1) is a plan view of the electromagnetic coil 100A, and FIG. 4A (B1) is a plan view of the electromagnetic coil 100B. The electromagnetic coil 100A and the electromagnetic coil 100B are formed of conductors of the same material and the same diameter. FIG. 4A(A2) is a side view of the electromagnetic coil 100A, and FIG. 4A(B2) is a side view of the electromagnetic coil 100B. As is understood from the comparison between FIG. 4A(A1) and FIG. 4A(B1) and between FIG. 4A(A2) and FIG. 4A(B2), in the state where the electromagnetic coils 100A and 100B are formed on the plane, the electromagnetic coils 100A and 100B have the same shape. Besides, the number of turns of the electromagnetic coil 100A and the number of turns of the electromagnetic coil 100B are the same number. Accordingly, the electric resistance of the electromagnetic coil 100A and the electric resistance of the electromagnetic coil 100B have the same value. Besides, the inductance of the electromagnetic coil 100A and the inductance of the electromagnetic coil 100B have the same value. When the thickness of the bundle of conductors of each of the electromagnetic coils 100A and 100B is φ1, and when the interval between the coil bundles in the effective coil area is L2, a relation of L2≈2×φ1 is established.

FIG. 4B is an explanatory view showing a state before the electromagnetic coils 100A and 100B are overlapped. FIG. 4B(A1) is a view showing the electromagnetic coil 100A viewed from the radiation direction of the rotation shaft 230, and FIG. 4B(B1) is a view showing the electromagnetic coil 100B viewed from the radiation direction of the rotation shaft 230. FIG. 4B(A2) is a view showing the electromagnetic coil 100A viewed from the direction parallel to the rotation shaft 230, and FIG. 4B(B2) is a view showing the electromagnetic coil 100B viewed from the direction parallel to the rotation shaft 230. As shown in FIG. 4B(A1) and 4B(A2), although the whole of the electromagnetic coil 100A is bent from the plane shape along the cylindrical surface, and the coil end area of the electromagnetic coil 100A is bent in the outside direction from the cylindrical surface. On the other hand, as shown in (B1) and (B2) in FIG. 4B, the whole of the electromagnetic coil 100B is bent from the plane shape along the cylindrical surface, and the coil end area of the electromagnetic coil 100B is not bent in the outside direction from the cylindrical surface. Incidentally, even if the shape is changed, the electric resistance is not changed, and therefore, the electric resistance of the electromagnetic coil 100A and the electric resistance of the electromagnetic coil 100B have the same value. On the other hand, although the electromagnetic coil 100A and the electromagnetic coil 100B have the same shape in the effective coil area, the shapes in the coil end area are different. That is, with respect to the inductance, although the inductances caused by the effective coil area are the same, the inductances caused by the coil end area are different. That is, the inductance of the electromagnetic coil 100A and the inductance of the electromagnetic coil 100B are slightly different from each other. In general, when the coil end area is bent, an area s of the electromagnetic coil 100A in the magnetic flux direction is reduced, and therefore, the inductance is reduced. For example, the inductance L of the coil is expressed by the following expression.

$$L = \frac{k \times μ \times {n}^{2} \times s}{l}$$

Here, k represents Nagaoka coefficient, μ represents magnetic permeability, n represents the number of turns of the electromagnetic coil, s represents the cross section of the electromagnetic coil, and l represents the length of the electromagnetic coil.

FIG. 4C is an explanatory view showing a state where the electromagnetic coils 100A and 100B are overlapped. Incidentally, FIG. 4C shows the coil back yoke 115. The conductor bundles of the two electromagnetic coils 100B in the effective coil area are received between the two conductor bundles of the electromagnetic coil 100A in the effective coil area. Besides, the conductor bundles of the two electromagnetic coils 100A in the effective coil area are received between the two conductor bundles of the electromagnetic coil 100B in the effective coil area, and the electromagnetic coils 100A and 100B do not overlap each other. Besides, the coil end area of the electromagnetic coil 100A is bend outward from the cylindrical surface, and is shifted from the coil end area of the electromagnetic coil 100B in the radius direction. As stated above, the coil end area of the electromagnetic coil 100A is bent outward, so that the electromagnetic coils 100A and 100B can be arranged on the same cylindrical surface without collision. In this embodiment, the thickness φ1 of the conductor bundle of each of the electromagnetic coils 100A and 100B and the interval L2 between the coil bundles in the effective coil area have the relation of L2≈2×φ1. That is, since the cylindrical surface on which the electromagnetic coils 100A and 100B are arranged is almost occupied by the conductor bundles of the electromagnetic coils 100A and 100B, the occupancy factor of the electromagnetic coils can be increased and the efficiency of the electric motor 10 (FIGS. 1A and 1B) can be improved.

Next, the electric resistances and inductances of the electromagnetic coils 100A and 100B will be described. The shapes of the electromagnetic coils 100A and 100B shown in FIG. 4B are the same as the shapes of the electromagnetic coils 100A and 100B shown in FIG. 4C. Accordingly, as described in FIG. 4B, the electric resistance of the electromagnetic coil 100A and the electric resistance of the electromagnetic coil 100B have the same value. As described in FIG. 4B, with respect to the inductance when the coil back yoke 115 does not exist, although the inductances caused by the effective coil area are the same, the inductances caused by the coil end area are different, and the inductance of the electromagnetic coil 100A is slightly different from the inductance of the electromagnetic coil 100B. However, as in the embodiment, in the state where the coil back yoke 115 and the electromagnetic coil 100A overlap each other, with respect to the inductance of the electromagnetic coil 100A, the inductance of the portion where the coil back yoke 115 and the electromagnetic coil 100A overlap each other, that is, the effective coil area becomes dominant. The same applies to the electromagnetic coil 100B. Here, since the effective coil area of the electromagnetic coil 100A and the effective coil area of the electromagnetic coil 100B have the same shape, the inductance of the electromagnetic coil 100A and the inductance of the electromagnetic coil 100B have almost the same value. Accordingly, since the Lorentz force between the electromagnetic coil 100A and the permanent magnet 200 and the Lorentz force between the electromagnetic coil 100B and the permanent magnet 200 have the same magnitude, both are balanced, and consequently, the efficiency of the electric motor 10 can be improved.

The electric motor 10 of this embodiment includes the permanent magnet 200, the two-phase coreless (air core) electromagnetic coils 100A and 100B, and the coil back yoke 115. Each of the electromagnetic coils 100A and 100B of the respective phases includes the effective coil area and the coil end area. The effective coil areas of the electromagnetic coils 100A and 100B of the respective phases have the same shape. The effective coil areas of the electromagnetic coils 100A and 100B of the respective phases are arranged on the cylindrical surface between the permanent magnet 200 and the coil back yoke 115. The coil end area of the electromagnetic coil 100A is bent in the outside direction of the cylindrical surface. Further, the electromagnetic coils 100A and 100B of the respective phases have the same electric resistance value. Besides, the coil back yoke 115 covers the effective coil areas of the electromagnetic coils 100A and 100B of the respective phases, and does not cover the coil end area. Thus, the inductances of the electromagnetic coils 100A and 100B of the respective phases have substantially the same value. Accordingly, since the Lorentz force between the electromagnetic coil 100A and the permanent magnet 200 and the Lorentz force between the electromagnetic coil 100B and the permanent magnet 200 have the same magnitude, both can be balanced, and consequently, the efficiency of the electric motor 10 can be improved.

Further, as described in FIG. 4A to FIG. 4C, the electromagnetic coils 100A and 100B of the respective phases are formed such that the electromagnetic coils 100A and 100B having the same shape on the plane are bent along the cylindrical surface, and the coil end area of the electromagnetic coil 100A of an A-phase is bent in the outside direction of the cylindrical surface. Thus, the electromagnetic coils 100A and 100B of the respective phases can be easily made to have the same electric resistance value.

Besides, the interval L2 between the bundles of the conductors forming the coils in the two effective coil areas of the electromagnetic coils 100A and 100B of the respective phases is twice the thickness φ1 of the bundle of the conductor coil in the effective coil areas of the electromagnetic coils 100A and 100B. Thus, the occupancy factor of the electromagnetic coil can be increased by mutually arranging the two-phase coils effectively, and the efficiency of the electric motor 10 can be improved.

### Second Embodiment

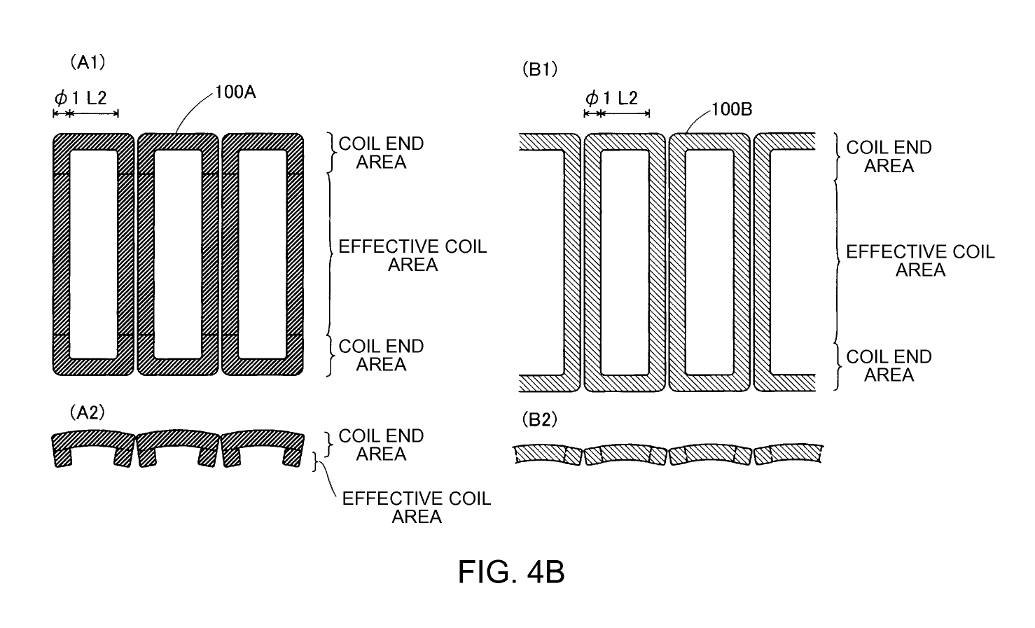

FIGS. 5A and 5B are explanatory views showing a second embodiment. FIG. 5A is a schematic view showing a section of an electric motor 10 cut along a plane parallel to a rotation shaft 230 and viewed from a direction perpendicular to the section. FIG. 5B is a schematic view showing a section of the electric motor 10 cut along a cut line 5B-5B perpendicular to the rotation shaft 230 and viewed from a direction perpendicular to the section. In the first embodiment, the coil end area of the electromagnetic coil 100A is bent in the outside direction of the cylindrical surface on which the effective coil areas of the electromagnetic coils 100A and 100B are arranged. On the other hand, in the second embodiment, the coil end area of the electromagnetic coil 100A is bent in the inside direction of the cylindrical surface on which the effective coil areas of the electromagnetic coils 100A and 100B are arranged. Besides, in the second embodiment, the magnetic sensor 300 is not provided, and instead, an encode 320 is provided. The reason why the magnetic sensor 300 is not provided is as follows. That is, in the second embodiment, since the coil end area of the electromagnetic coil 100A is bent in the inside direction of the cylindrical surface, if the magnetic sensor 300 is arranged similarly to the first embodiment, the coil end area of the electromagnetic coil 100A is positioned between the magnetic sensor 300 and the permanent magnet 200. That is, the magnetic sensor 300 is positioned near the coil end area of the electromagnetic coil 100A. As a result, there is a fear that the magnetic flux density received by the magnetic sensor 300 is influenced by the magnetic flux generated by the current flowing through the electromagnetic coil 100A. Incidentally, in this embodiment, the encoder 320 for detecting a mechanical angle of the permanent magnet 200 is provided instead of providing the magnetic sensor 300.

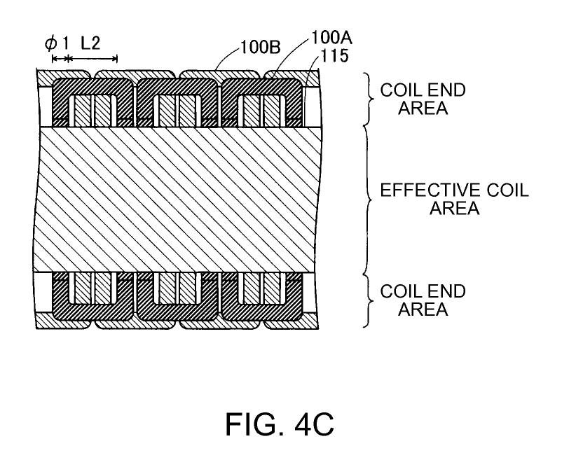

FIG. 6 is an enlarged explanatory view showing a difference between the coil shapes of the electromagnetic coils 100A and 100B of the second embodiment. The electromagnetic coil 100A is bent in the inside direction of the cylindrical surface at a point P4 and extends to a point P5. The electromagnetic coil 100B is not bent at the point P4 and extends to a point P6 along the cylindrical surface. The length L3 of the electromagnetic coil 100A from the point P4 to the point P5 is equal to the length L3 of the electromagnetic coil 100B from the point P4 to the point P6. The shapes of the electromagnetic coils 100A and 100B from the point P4 to the point P5 and the point P6 are the same. Accordingly, the values of the electric resistances of the electromagnetic coils 100A and 100B are the same. Besides, the point P4 does not overlap the coil back yoke 115. That is, a portion of the electromagnetic coil 100A which is not bent is the effective coil area, and the effective coil area of the electromagnetic coil 100A and the effective coil area of the electromagnetic coil 100B have the same shape. The effective coil areas of the electromagnetic coils 100A and 100B overlap the coil back yoke 15, and the inductance in the effective coil area is dominant in both the inductance of the electromagnetic coil 100A and the inductance of the electromagnetic coil 100B. Accordingly, the inductances of the electromagnetic coils 100A and 100B have substantially the same value.

Accordingly, also in the second embodiment, the electric resistance of the electromagnetic coil 100A and the electric resistance of the electromagnetic coil 100B can be made to have the same value, and the inductance of the electromagnetic coil 100A and the inductance of the electromagnetic coil 100B can be made to have substantially the same value. As a result, the Lorentz force between the electromagnetic coil 100A and the permanent magnet 200 and the Lorentz force between the electromagnetic coil 100B and the permanent magnet 200 can be made to have the same magnitude. Thus, both is balanced, and consequently, the efficiency of the electric motor 10 can be improved.

### Third Embodiment

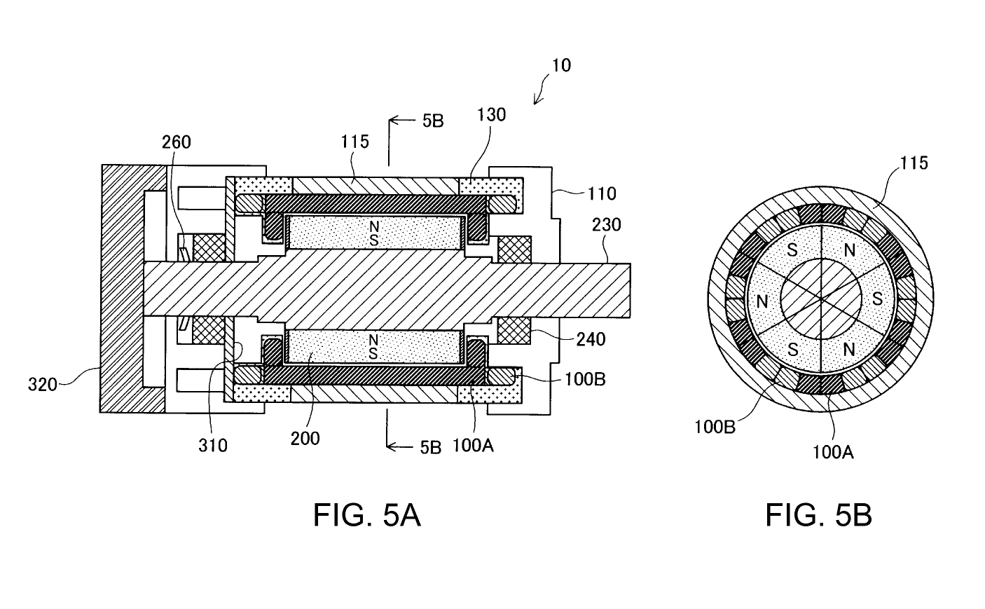

FIGS. 7A and 7B are explanatory views showing a third embodiment. FIG. 7A is a schematic view showing a section of an electric motor 10 cut along a plane parallel to a rotation shaft 230 and viewed from a direction perpendicular to the section. FIG. 7B is a schematic view showing a section of the electric motor 10 cut along a cut-line 7B-7B perpendicular to the rotation shaft 230 and viewed from a direction perpendicular to the section. In the first and the second embodiments, the coil end area of the electromagnetic coil 100A is bent in the outside direction or the inside direction of the cylindrical surface, and the coil end area of the electromagnetic coil 100B is not bent in the outside direction or the inside direction of the cylindrical surface. On the other hand, in the third embodiment, differently from the first and the second embodiments, the coil end area of the electromagnetic coil 100A is bent in the outside direction of the cylindrical surface, and the coil end area of the electromagnetic coil 100B is bent in the inside direction of the cylindrical surface.

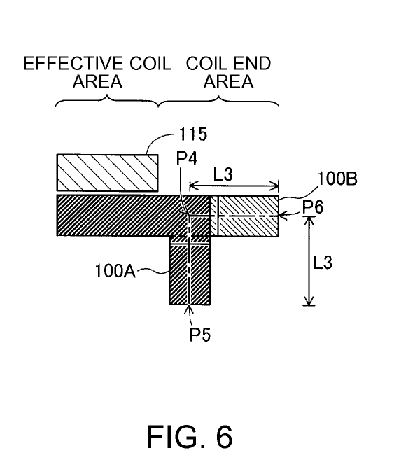

FIG. 8 is an enlarged explanatory view showing a difference between the coil shapes of the electromagnetic coils 100A and 100B of the third embodiment. The electromagnetic coil 100A is bent in the outside direction of the cylindrical surface at a point P7 and extends to a point P8. The electromagnetic coil 100B is bent in the inside direction of the cylindrical surface at the point P7 and extends to a point P9. A length L4 of the electromagnetic coil 100A from the point P7 to the point P8 is the same as a length L4 of the electromagnetic coil 100B from the point P7 to the point P9. The electromagnetic coils 100A and 100B in the left direction from the point P7 in the drawing have the same shape. Accordingly, the electric resistances of the electromagnetic coils 100A and 100B have the same value.

When the length of each of the electromagnetic coils 100A and 100B is L5, the coil end area of the electromagnetic coil 100A is bent in the outside direction by L5/2, and the coil end area of the electromagnetic coil 100B is bent in the inside direction by L5/2. Incidentally, in the first embodiment, the coil end area of the electromagnetic coil 100A is bent in the outside direction by L5. That is, the deformation amount of the electromagnetic coil 100A in the third embodiment is half of the deformation amount of the electromagnetic coil 100A in the first embodiment. Accordingly, the inductance value of the electromagnetic coil 100A of the third embodiment is closer to the inductance value of the electromagnetic coil 100B deformed cylindrically as shown in FIG. 4B than the inductance value of the electromagnetic coil 100A of the first embodiment. Besides, also with respect to the electromagnetic coil 100B, since the coil end area of the electromagnetic coil 100B is bent in the inside direction by L5/2, the inductance value of the electromagnetic coil 100B of the third embodiment is closer to the inductance value of the electromagnetic coil 100A of the first embodiment than the inductance value of the electromagnetic coil 100B deformed cylindrically as shown in FIG. 4B. Accordingly, the difference between the inductance of the electromagnetic coil 100A and the inductance of the electromagnetic coil 100B of the third embodiment is small as compared with the first embodiment.

Accordingly, also in the third embodiment, the electric resistance of the electromagnetic coil 100A and the electric resistance of the electromagnetic coil 100B can be made to have the same value, and the inductance of the electromagnetic coil 100A and the inductance of the electromagnetic coil 100B can be made to have substantially the same value. As a result, since the Lorentz force between the electromagnetic coil 100A and the permanent magnet 200 and the Lorentz force between the electromagnetic coil 100B and the permanent magnet 200 can be made to have the same magnitude, both are balanced, and consequently, the efficiency of the electric motor 10 can be improved.

Incidentally, in the third embodiment, although the magnetic sensor 300 is provided, since the electromagnetic coil 100B is bent in the inside direction of the cylindrical surface, similarly to the second embodiment, the encoder 320 may be provided without providing the magnetic sensor 300.

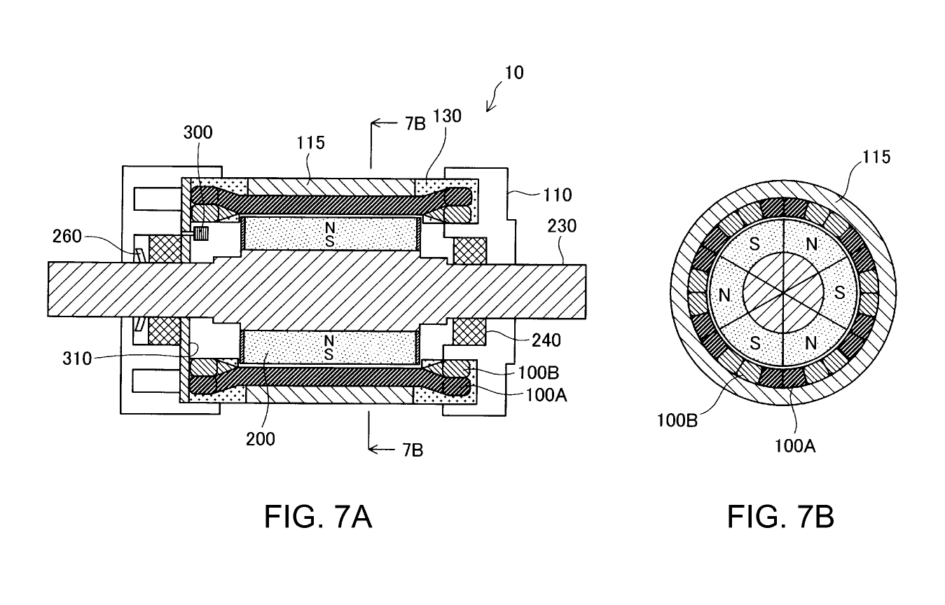

FIG. 9 is an explanatory view showing an electric bicycle (electric assist bicycle) as an example of a moving body using a motor/generator according to a modified example of the invention. In a bicycle 3300, a motor 3310 is provided on a front wheel, and a control circuit 3320 and a rechargeable battery 3330 are provided on a frame below a saddle. The motor 3310 uses power from the rechargeable battery 3330 and drives the front wheel to assist the traveling. Besides, at the time of braking, the power regenerated by the motor 3310 is charged into the rechargeable battery 3330. The control circuit 3320 is a circuit to control driving and regeneration of the motor. As the motor 3310, the foregoing various electric motors 10 can be used.

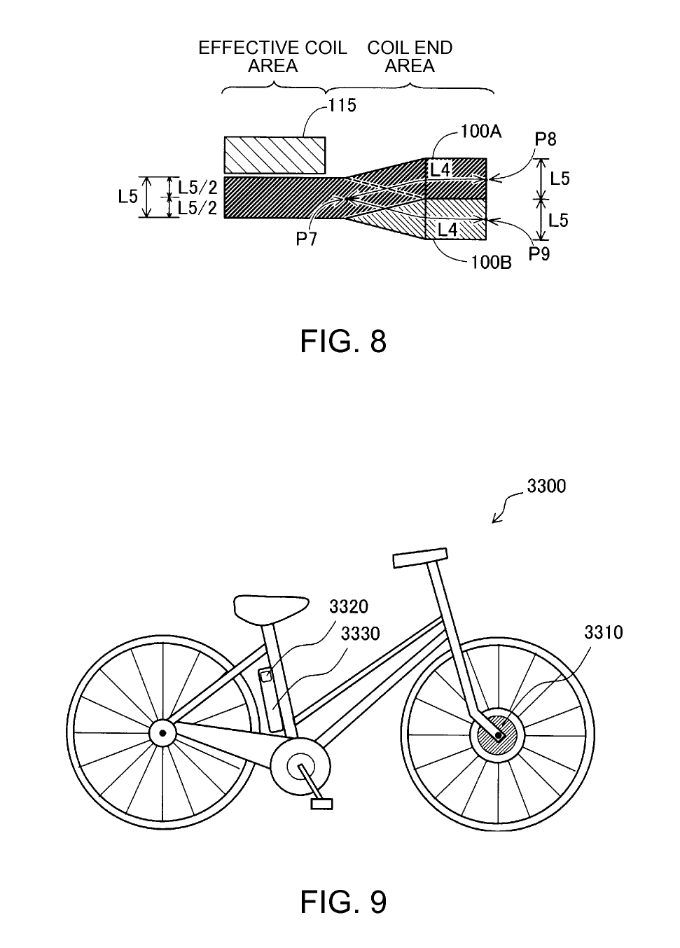

FIG. 10 is an explanatory view showing an example of a robot using a motor according to a modified example of the invention. A robot 3400 includes a first arm 3410, a second arm 3420 and a motor 3430. The motor 3430 is used when the second arm 3420 as a driven member is horizontally rotated. As the motor 3430, the foregoing various electric motors 10 can be used.

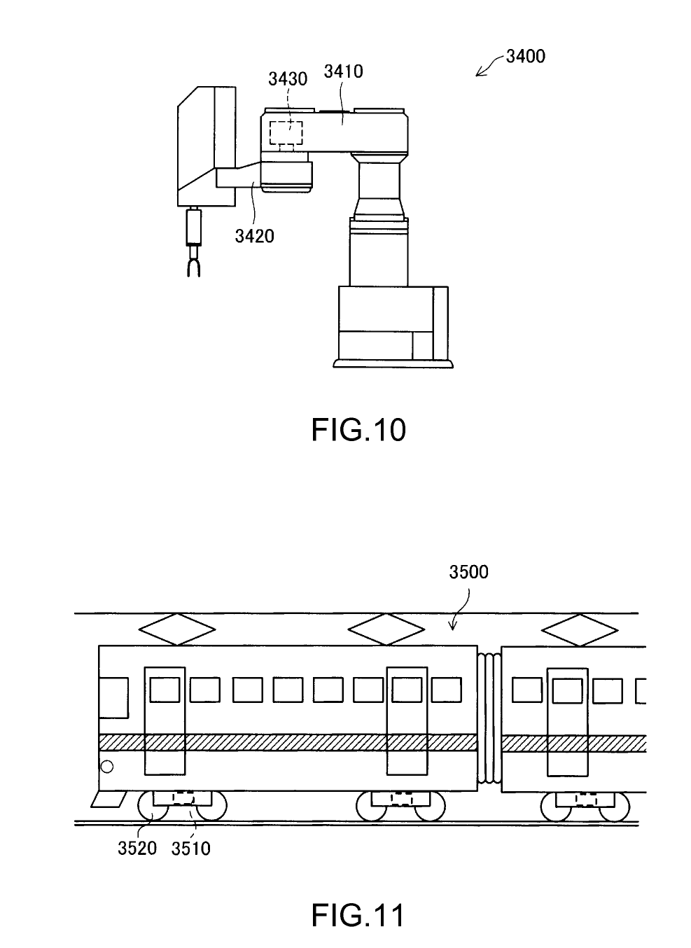

FIG. 11 is an explanatory view showing a railway vehicle using a motor according to a modified example of the invention. A railway vehicle 3500 includes an electric motor 3510 and a wheel 3520. The electric motor 3510 drives the wheel 3520. Further, the electric motor 3510 is used as a generator at the time of braking of the railway vehicle 3500, and the power is regenerated. As the electric motor 3510, the foregoing various electric motors 10 can be used.

Although the embodiments of the invention have been described based on some examples, these embodiments of the invention are intended to facilitate the understanding of the invention and are not limit the invention. The invention can be modified and improved without departing from the gist thereof and the scope recited in the claims, and the invention naturally includes the equivalent thereof.

The present application claims priority based on Japanese Patent Application No. 2011-108958 filed on May 16, 2011, the disclosure of which is hereby incorporated by reference in its entirety.

What is claimed is:

1. A coreless electric machine apparatus including a first and a second cylindrical member movable relative to each other, comprising:
a permanent magnet arranged on the first member;
two-phase coreless electromagnetic coils arranged on the second member; and
a coil back yoke arranged on the second member, wherein
the electromagnetic coils include effective coil areas for generating a force to move the first member relatively to the second member, and coil end areas,
the effective coil areas of the two-phase electromagnetic coils have same shape and are arranged in a cylindrical area between the permanent magnet and the coil back yoke,
the coil end area of a first phase electromagnetic coil of the two-phase electromagnetic coils is bent in an inside direction or an outside direction of the cylindrical surface,
the two-phase electromagnetic coils have same electric resistance value, and
the coil back yoke covers outer peripheral areas of the effective coil areas and does not cover outer peripheral areas of the coil end areas.

2. The coreless electric machine apparatus according to claim 1, wherein a shape of the first phase electromagnetic coil before the coil end area is bent is equal to a shape of a second phase electromagnetic coil, and the coil end area of the first phase electromagnetic coil is bent in the inside direction or the outside direction of the cylindrical surface.

3. The coreless electric machine apparatus according to claim 1, wherein the coil end area of a second phase electromagnetic coil of the two-phase electromagnetic coils is bent in a direction opposite to the direction in which the coil end area of the first phase electromagnetic coil is bent.

4. The coreless electric machine apparatus according to claim 1, wherein an interval between the two-phase electromagnetic coils forming the effective coil areas is twice a thickness of the electromagnetic coil in the effective coil area of the electromagnetic coil.

5. A moving body comprising a coreless electric machine apparatus according to claim 1.

6. A moving body comprising a coreless electric machine apparatus according to claim 2.

7. A moving body comprising a coreless electric machine apparatus according to claim 3.

8. A moving body comprising a coreless electric machine apparatus according to claim 4.

9. A robot comprising a coreless electric machine apparatus according to claim 1.

10. A robot comprising a coreless electric machine apparatus according to claim 2.

11. A robot comprising a coreless electric machine apparatus according to claim 3.

12. A robot comprising a coreless electric machine apparatus according to claim 4.
